(19) United States
(12) Patent Application Publication
(10) Pub. No.: US 2017/0083845 A1
(43) Pub. Date: Mar. 23, 2017

(54) GENERIC ENTITY TRANSLATIONS USING PRIORITY QUEUING

(71) Applicant: HomeAway, Inc., Austin, TX (US)

(72) Inventors: Chris Karcher, Cedar Park, TX (US); Dustin Greiner, Austin, TX (US)

(73) Assignee: HomeAway, Inc., Austin, TX (US)

(21) Appl. No.: 14/862,132

(22) Filed: Sep. 22, 2015

(51) Int. Cl. G06Q 10/06; G06Q 30/02; G06F 17/28; G06F 17/30

(52) U.S. Cl. CPC G06Q 10/06313; G06F 17/30876; G06Q 30/0206; G06F 17/2872

(57) ABSTRACT

Various embodiments relate generally to managing translation requests for content in a listing management system. In one or more embodiments, a method can include receiving data representing a plurality of requests to translate text for a plurality of entities, each request originating from a business unit having an allocated number of translation units. Requests may be analyzed to identify a translation cost for each request. A priority can be determined for each request based on its attributes. The requests may be sent to one or more translation engines based on the priority of each request. Translated entities from the one or more translation engines may be received and stored in association with the one or more listings.

### FIELD

Various embodiments relate generally to electrical and electronic hardware, computer software, wired and wireless network communications, and distributed software applications for managing translations of content. More specifically, a system and a method provide for a priority queue of translating content based on, for example, an allocation of translation units for a business unit and other attributes of the content being translated.

### BACKGROUND

Conventional techniques for translating content have evolved away from mere pen-and-paper implementations as the complexity increases have increasingly relied on technological solutions. With the advent of computing devices, translating content electronically has enabled content providers on the Internet to reach wider audiences around the world at a cheaper cost than human-delivered translations.

For example, some conventional approaches to translating content electronically utilize translation engines provided by various companies and/or tools for free or at a low cost. An Internet user may simply copy and paste text into free translation engines through a web browser, for example. Using translation engines, users may communicate with each other regardless of the original language of the content. Despite the ease of using translation engines, conventional translation systems are not well-suited to facilitate translating whole websites without expending resources or requiring manual intervention.

While conventional approaches are functional, the usual structures and/or functionalities for managing the translation of content into multiple languages are not suited to the increasing technological demands required to optimally perform the translations.

Thus, what is needed is a solution for effectively managing the translation costs of content delivered to users worldwide without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a high-level block diagram depicting a process of prioritizing translation requests in a listing management system, according to an embodiment;

FIG. 2 is a network diagram of a system for prioritizing translation requests in a listing management system, showing a block diagram of the listing management system, according to an embodiment;

FIG. 3 is an interaction diagram of a process for prioritizing translation requests, according to an embodiment;

FIG. 4 is a flow chart of a process for managing translation requests, according to some examples;

FIG. 5A is a functional block diagram depicting an example of how an attribute analyzer operates on a prioritized translation queue, according to some examples;

FIG. 5B is a functional block diagram depicting an example of how an attribute analyzer operates on a translation request, according to some examples; and

FIG. 6 illustrates an exemplary computing platform disposed in a device configured to prioritize translation requests on implementation of an attribute analyzer in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Traveling around the world has never been easier in the Internet age. People wishing to travel cheaply, with family, or luxuriously may search various websites for the best deals and/or best amenities for hotels, vacation homes, and short-term rentals. With the advent of on-demand housing software applications, owners and travelers may interact with property listings on various websites, mobile applications, and application services. For example, a homeowner may list their property on an on-demand housing software application with an availability, rental cost, description of the property, and photos with accompanying captions describing the property. Travelers may browse through the various property listings, bookmark or indicate interest in a particular listing, and submit reviews for property listings via the on-demand housing software application provided through a mobile application operating on a mobile device or a website running on a web browser accessed through the Internet.

A property listing may include several entities, or portions of text that are associated with the property listing. As mentioned above, a property listing may include an overview or general description, an availability as displayed on a calendar, a price, amenities, reviews, nearby attractions as displayed on a map, contact information about the owner providing the listing, and other incidental text describing the listing, such as a geographic region where the property is located (e.g., “Napa”), highlighted terms describing the property listing (e.g., “Cabernet Corner—Riverfront, Dock, Downtown, Wine Country!”), and template language that may be repeatedly used in other listings (e.g., “per night,” “minimum stay,” “nights,” “sleeps,” “about the owner,” etc.).

Traditional content translation services require a user submitting a request to translate a whole page of content, or a complete document, regardless of whether similar text had been previously translated. For example, a user may request that a particular webpage at a specific Uniform Resource Locator (URL) be translated from its original language of French into English. The request may be made via a service, such as GOOGLE TRANSLATE. Alternatively, the user may download a browser that enables automated translation via a browser extension or script and then browse the page needing translation. However, these content translation services are not scalable for a large volume of documents, such as the hundreds of thousands of property listings published on various housing software applications.

Translation engines may also charge a translation fee per character of text received for translation. Because property listings have similar template language, as mentioned above, such as “owner,” “nights,” “price,” and so forth, translating pages of content on housing software application wastes limited financial resources. Additionally, a housing software application may have a limited amount of resources available for translating content due to the scale and revenue structure of the application. However, translating content is necessary to serve a global audience of users that read and speak multiple languages.

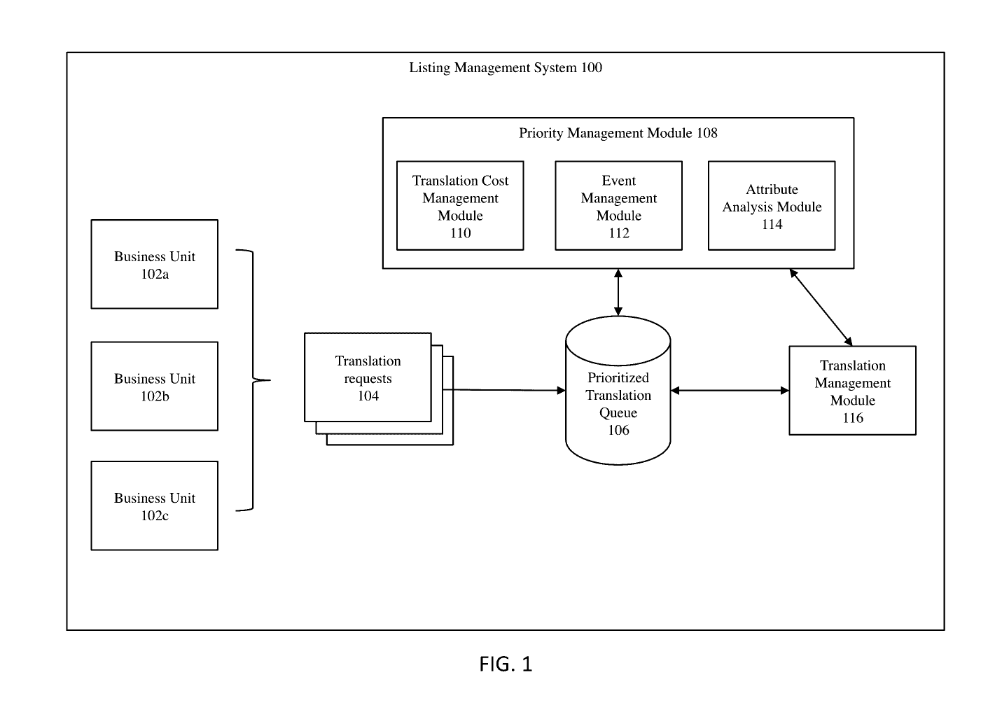

FIG. 1 is a high-level block diagram depicting a listing management system 100, according to some embodiments. The listing management system 100 includes a priority management module 108 that is configured to prioritize translation requests 104 associated with various business units 102 (e.g., business units 102a, 102b, and 102c).

FIG. 1 and the other figures use like reference numerals to identify like elements. A letter after a reference numeral, such as “102a,” indicates that the text refers specifically to the element having that particular reference numeral. A reference numeral in the text without a following letter, such as “102,” refers to any or all of the elements in the figures bearing that reference numeral (e.g., “102” in the text refers to reference numerals “102a,” “102b,” and/or “102c” in the figures). Only three business units 102 are illustrated in FIG. 1 in order to simplify and clarify the description.

Business units 102 in a listing management system 100 may be defined as data processes, objects, and/or modules representing any recognized organization within the listing management system 100. For example, business units 102 may include functional components of a company, such as sales, marketing, research and development, operations, and so forth. Business units 102 may also include geographical sub-divisions of a component of a company, such as European (EU) sales, Asia-Pacific (APAC) sales, Australian (AUS) sales, North American and South American (AMER) sales, and so forth. Business units 102 may also include subsidiaries of a company or other partnering companies that utilize the housing software application. For example, VACATION RENTALS BY OWNER (VRBO), HOMEAWAY, VACATIONRENTALS.COM, HOMELIDAYS, OWNERSDIRECT, ABRITEL, ALUGUETEMPORADA, FEWODIREKT, TOPRURAL, BOOKABACH, STAYZ, and TRAVELMOB may all be various brands and/or subsidiaries of a parent company providing a housing software application that supports the users (e.g., owners, property managers, and travelers) of those various brands' websites, mobile applications, and software services. Each brand may be considered an organization within the listing management system 100 that may be represented as business unit 102, in one embodiment.

Translation requests 104 may be received by the listing management system 100 through various sources. For example, an owner may wish to have his property listing translated in all languages across all brands supported by the housing software application. That translation request 104 may have various attributes, such as whether the owner has purchased a global bundle that enables the listing to be provided across several global brands, or whether the owner has purchased a different type of subscription for advertising the property listing. Subscriptions may be tiered such that a property listing may include more benefits, such as translation, based on the subscription level. For example, the owner may pay-per-booking, purchase an annual subscription, or use professional services of a property manager for listing a property. A translation request 104, thus, may originate from any of these sources. The translation request 104 originating from a user may be associated with an allocated number of translation units for a business unit 102 supporting the user, such as sales or customer service, for example.

A translation request 104 may also be made from a business unit 102. For example, a new brand may be purchased, where the brand's website and platform were only presented in Spanish. However, to open the listings to the global audience, the marketing team may request that the entire website and application be translated into English, German, and French. This type of translation request 104 made by a particular business unit 102 may be associated with a particular allocation of translation units, in one embodiment. In another embodiment, this type of translation request 104 may not be associated with any allocation of translation units, but the request 104 may be marked with high priority.

As further illustrated in FIG. 1, data representing the translation request 104, received through an application or other user interface with the listing management system 100, may be placed in a prioritized translation queue 106. A priority management module 108 may include a translation cost management module 110, an event management module 112, and an attribute analysis module 114 to prioritize the translation requests 104 in the prioritized translation queue 106.

A translation cost management module 110 may prioritize a translation request 104 based on whether the cost of translating the text being requested for translation may be covered by the allocated number of translation units associated with the translation request 104. For example, a translation request 104 may include a request to translate only the property listing overview textual description and prices into the top 5 languages supported by the listing management system 100 and not the photo captions. Thus, the translation request 104 includes translation costs for two entities in the listing. Various text for the requested entities may have already been translated, such as “nights” and “price,” where other text may need translating.

The translation cost management module 110 may determine the actual cost of translating the requested entities and also determine whether that cost may be covered by one or more budgets, or allocated number of translation units, supported by business units 102. These two attributes may then be saved within the data representing the translation request 104 and the priority management module 108 may re-prioritize the translation request 104 in the prioritized translation queue 106, in one embodiment.

An event management module 112 may receive various event information from the listing management system 100. For example, a business unit 102 may need translation of a particular listing ASAP based on a high-value of the listing. The translation request 104 may have been already placed in the prioritized translation queue 106, so the event management module 112 may re-prioritize the translation request 104 with a higher priority based on the newly received event information, in one embodiment. Other events may include a forced translation event received from a customer service representative, a change in status based on an owner upgrading a subscription plan or purchasing a global bundle that now covers a translation cost, a change in status of an allocated number of translation units for one or more business units 102, and the like.

An attribute analysis module 114 may examine one or more attributes of translation requests 104 in the prioritized translation queue 106 to determine a priority of the translation requests 104. In one embodiment, the attribute analysis module 114 may include a priority hierarchy based on attributes of a translation request 104. For example, a translation request 104 may have a higher priority than other translation requests 104 if the request is associated with a business unit 102 having an allocated number of translation units available for the request, if the request is associated with a listing that has been paid for, meaning that the owner purchased a subscription plan instead of a “free” pay-per-booking plan.

The attribute analysis module 114 may also examine whether a translation of text in a listing associated with the translation request 104 is new versus existing. For example, a translation of text may be tagged with a status attribute of “new” to differentiate the request from existing translations. To reduce the amount of unnecessary translations, an attribute for a translation request 104 may track the status as new or existing. In one embodiment, the attribute of a “new” status of a listing may be second in a priority hierarchy after the “paid” attribute. In another embodiment, a priority management module 108 may use an algorithm to score translation requests 104 such that the attribute analysis module 114 may determine a weighted score based on the attributes of the translation requests 104.

A translation management module 116 may retrieve the most prioritized translation request 104 from the prioritized translation queue 106 and process the request. Various translation engines may be used to translate requested entities of a listing, for example. The translation management module 116 may send the text within the requested entities to the translation engines and store data representing the translated entities in the listing management system 100. The translation management module 116 may also reduce the allocated number of translation units for business units 102 based on the processed translation requests 104. Further, the translation management module 116 may reconcile the allocated numbers of translation units for multiple business units 102 that may be associated with a particular translation request 104. For example, if a translation request 104 is associated with two allocations of translation units for two business units 102a and 102b, representing the EU and AUS sales teams, the translation management module 116 may determine, based on a number of factors, which allocation of translation units to deduct the cost of translating the entities requested in the translation request 104. In one embodiment, the translation cost may be shared among the business units 102a and 102b. In another embodiment, the translation cost may be deducted from the business unit 102 having a higher allocation of translation units. In a further embodiment, the translation cost may be deducted from a business unit 102 representing the area where the property listing associated with the translation request 104 is located. In yet another embodiment, the translation cost may be deducted from a business unit 102c based on the brand through which the owner listed the property. For example, a business unit 102c may represent the brand TOPRURAL, and an owner may list his property through that brand. In one embodiment, the translation management module 116 may identify the business unit 102 to deduct the translation cost of processing a translation request 104 based on a hierarchy of available allocations of translation units for business units 102 associated with the translation request 104.

### System Architecture

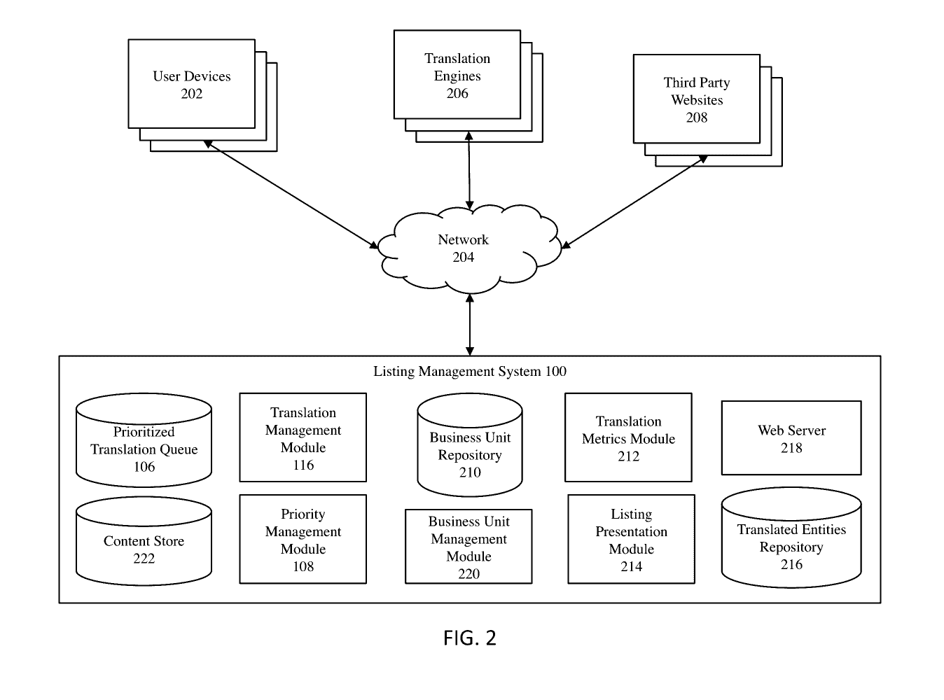

FIG. 2 is a high level block diagram illustrating a system environment suitable for managing prioritization of translation requests in a listing management system, in accordance with an embodiment. The system environment comprises one or more user devices 202, translation engines 206, third-party websites 208, the listing management system 100, and a network 204. In alternative configurations, different and/or additional modules can be included in the system.

The user devices 202 comprise one or more computing devices that can receive user input and can transmit and receive data via the network 204. Travelers, owners, and even administrators of the listing management system 100 may access the system 100 through one or more user devices 202. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, wearable device, etc. The user device 202 is configured to communicate via network 204. The user device 202 can execute an application, for example, a browser application that allows a user of the user device 202 to interact with the listing management system 100. In another embodiment, the user device 202 interacts with the listing management system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the listing management 100, according to some embodiments. The listing management system 100 includes a prioritized translation queue 106, a translation management module 116, a priority management module 108, a business unit repository 210, a business unit management module 220, a translation metrics module 212, a listing presentation module 214, a web server 218, a content store 222, and a translated entities repository 216. In other embodiments, the listing management system 100 may include additional, fewer, or different modules for various applications. Conventional components such as network interfaces, security functions, load balancers, failover servers, management and network operations consoles, and the like are not shown so as to not obscure the details of the system.

The web server 218 links the listing management system 100 via the network 204 to one or more user devices 202; the web server 218 serves web pages, as well as other web-related content, such as Java, Flash, XML, and so forth. The web server 218 may provide the functionality of receiving and routing messages between the listing management system 100 and the user devices 202, for example, instant messages, queued messages (e.g., email), text and SMS (short message service) messages, or messages sent using any other suitable messaging technique. The user can send a request to the web server 218 to upload information, for example, images or videos that are stored in the content store 222. Additionally, the web server 218 may provide API functionality to send data directly to native user device operating systems, such as iOS, ANDROID, webOS, and RIM.

A content store 222 may store content uploaded by users of the listing management system 100. Content for a property listing may include text describing the property listing, photos and/or video of the property, reviews provided by travelers staying at the property listing, amenities available at the property, contact information of the owner or property manager, and so forth. Content for a traveler may include profile information about the traveler, in one embodiment. Content for users may be retrieved from third party websites 208, in one embodiment, such as a social networking system like TWITTER or FACEBOOK. The content store 222 may store this content for use in the listing management system 100.

A business unit repository 210 may store data representing business units 102 in the listing management system 100. An administrative user of a listing management system 100, such as a developer, salesperson, marketer, or other user granted administrative rights, may create and manage business units 102 through a business unit management module 220 such that the business units 102 are stored in the business unit repository 210. A business unit 102 may have one or more attributes, including an allocation of translation units, or a monetary budget for paying translation fees associated with translating text from one language to another language. Other attributes of a business unit 102 may include associated API keys for translation engines 206 and associated brands in the listing management system 100.

A translation metrics module 212 may provide a translation history of entities that have been translated. Metrics may include the cost of translation associated with each processed translation request 104, the date and time of translation, the date and time of entering the translation queue 106, the one or more languages that the text was translated into, a brand associated with the translation request 104, a character count of the text being translated, and type of translation (e.g., unit, field, entity, or listing). Other metrics may be generated by a translation metrics module 212, such as an estimated time to translate an entity, an estimated burn rate at which a budget (e.g., an amount of allocated translation units) is being exhausted, translation spend per brand (monthly, quarterly, yearly), budget utilization, and forecasting metrics, such as how much was translated last quarter, a history of when budget was exhausted, a history of how much was spent for translations last quarter, and so forth.

A translated entities repository 216 may store translated text of entities for reuse later by the listing management system 100. For example, the headline “Villa with garden” may be translated into Russian, Spanish, German, and Finnish. Because many properties may be described with a similar headline, it would be useful to save the translations of that entity into the translated entities repository 216. A translation management module 116, after processing the translation request 104 for the headline, would store the translated entity in the repository 216. In one embodiment, text may be hashed to ASCII values or using one or more hash algorithms, such as MD5 and LM. Using the hashed version of text, the translation management module 116 may determine whether the text has been translated successfully before storing the text in the translated entities repository 216.

Third party websites 208 may be linked to a listing management system 100 through a network 204. For example, a listing may provide an option for a traveler to share the listing with friends on a social networking system or via email. A link may be provided to share content from the listing management system 100 as a post on the social networking system website 208, in one embodiment. In another embodiment, a third party website 208 may be used to create a profile for a traveler on the listing management system 100. For example, a user of a social networking system website 208 may allow the listing management system 100 to access profile information on the social networking system website 208 for the user to populate similar profile information on the listing management system 100.

Translation engines 206 may be used to process the translation of text from one language to another language. An example of translation engine 206 may include logic to receive text from translation requests 104 through an API and to generate translations at an external server. In one embodiment, a translation engine 206 may charge for translation fees for text on a character by character basis. A separate API key may be associated with a particular allocation of translation units such that a particular translation request 104 may be assigned the API key of the business unit 102 covering the translation cost. In one embodiment, the translation management module 116 assigns the API key to the translation request 104 as part of processing the request 104 off the prioritized translation queue 106. In one embodiment, an API key may be associated with a general allocation of translation units not associated with a particular business unit 102.

A listing presentation module 214 provides listings for display to users of the listing management system 100. After an entity has been translated, the listing presentation module 214 may provide the translated entity for display on a website in the corresponding language of the translated entity. For example, HOMEAWAY may include a network of brands, as mentioned above, as well as different language versions of the HOMEAWAY website, such as HOMEAWAY.COM.IT for Italian, HOMEAWAY.COM.VN for Vietnamese, and so forth. Further, the listing presentation module 214 may provide a listing in a network of multiple brands as a result of the translated entities.

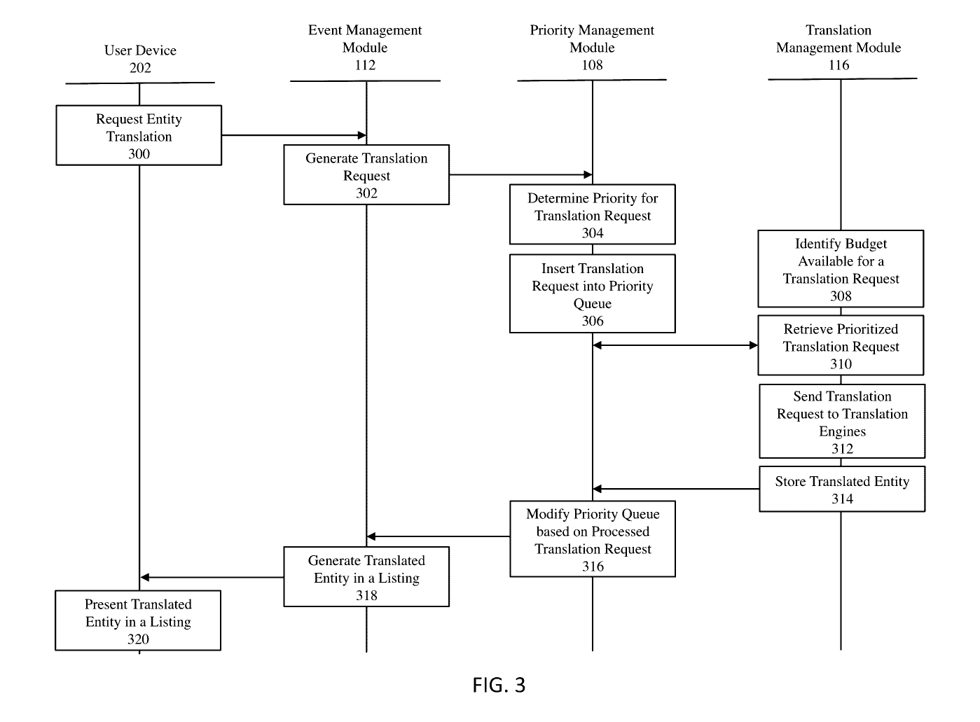

FIG. 3 is an interaction diagram of a process for prioritizing translation requests, according to an embodiment. An entity translation is requested 300 originating from a user device 202. For example, an owner may decide to translate her property listing in Australia from English to Vietnamese. The owner may request 300 the translation of her listing, which includes a plurality of entities, including a headline, an overview, and a price. An event management module 112 may generate 302 a translation request in response to the requested 300 entity translation. The translation request generated 302 by the event management module may include attributes about the request, such as a business unit 102 associated with the request, an estimated translation cost based on the text needing translation, whether parts of the listing may have been translated already, reducing the cost, whether the owner has paid for the listing to be translated, and so forth.

A priority for the translation request may be determined 304 by a priority management module 108 as a result of the generated 302 translation request. Returning to the example above, a priority may be determined 304 for the translation request based on attributes of the request, such as whether the listing associated with the request has been paid (paid versus unpaid) and whether an entity has been translated (new versus existing). The priority management module 108 may then, in one embodiment, insert 306 the translation request into a priority queue for translation based on the determined 304 priority of the translation request. In another embodiment, the translation request may be inserted 306 into the queue based on receiving a priority score or priority designation from the priority management module 108.

The translation management module 116 may identify 308 a budget available for a translation request, in one embodiment. For example, a budget may include an allocated number of translation units based on a fee charged by translation engines 206. Once a budget is identified 308 as available for a translation request, a prioritized translation request is retrieved 310 from the priority queue. In one embodiment, the translation management module 116 sends an indication to the priority management module 108 upon retrieving 310 the most prioritized translation request. The translation request may then be sent 312 to one or more translation engines for translating the requested entity or entities. In one embodiment, the translation request may be sent via an API to a translation engine. In response to the request, the translation engine may send back a translated entity comprising a translation of the requested text. The translated entity may then be stored 314 by the translation management module 116. An indication of the translated entity being stored 314 may be sent to the priority management module 108.

The priority management module 108 may modify 316 the priority queue based on the translation request being processed. In one embodiment, the priority queue may be modified 316 to move up the remaining queued requests in priority, for example. An indication that the priority queue was modified 316 based on the processed translation request may be sent to the event management module 112. In response to that indication, the translated entity may be generated 318 for inclusion in a listing. Returning to the previous example, the Australian property listing may now be populated with translated text for Vietnamese locales, where the translated text may include entities such as the headline, the description or overview of the property, and prices for the vacation rental, based on the translation request. An indication of the translated entity being generated 318 in the listing may be sent to the user device 202 that requested 300 the entity translation. The user device 202 may then present 320 the translated entity in the listing. This presentation may, in one embodiment, encompass publishing the translated entity in a listing on a website accessible by the user device 202.

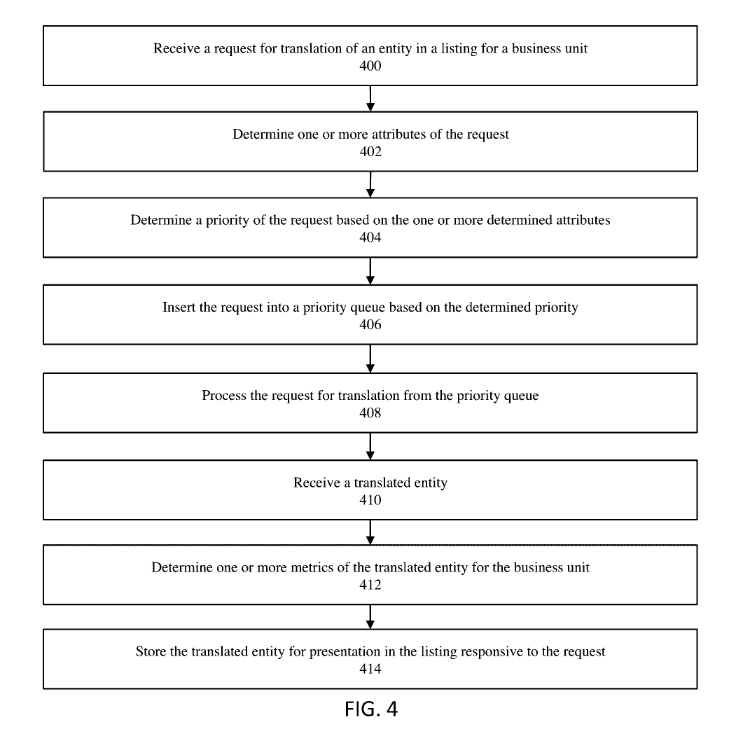

FIG. 4 is a flow chart of a process for managing translation requests, according to some examples. A request for translation of an entity in a listing may be received 400 for a business unit. The request for translation may be triggered from an event, such as a forced translation request by a customer service representative, an owner purchasing a global bundle for a listing such that the listing becomes “in network” and available for listing in one of the other brands hosted by the on-demand vacation rental software application, or receiving an indication from a user to translate specified entities in a listing into a particular language. The request may be assigned a business unit based on how the request was received 400, in one embodiment. For example, if the request was triggered from a customer service representative initiating a forced translation of the listing, the business unit associated with the request may be the customer relations department. As another example, if the request was triggered from the purchase of a global bundle by the owner, the business unit associated with the request may be the brand through which the owner purchased the global bundle, in one embodiment. In other embodiments, multiple business units may be associated with the request based on how the request was generated.

One or more attributes of the request may be determined 402. As discussed above, an attribute of the request that may be determined may include examining whether some of the requested entities have already been translated into the requested languages. If so, the translated entity may have an “existing” status, in one embodiment. If not, then the request may be assigned a “new” status. Other attributes that may be determined 402 include whether the listing has been paid for by the owner and whether there exists an allocation of translation units for any business units associated with the request.

A priority of the request may be determined 404 based on the one or more determined attributes. The highest priority for translation requests may be determined 404 based on whether the listing has been paid and whether the translation request is new and non-existing, in one embodiment. In another embodiment, the priority of the request may be determined 404 using a weighting algorithm, where the attribute of the listing being paid for has a higher weight than the attribute of the translation request being new. In a further embodiment, the priority of the request may be determined 404 by generating a priority score, where the score is determined by assigning points to various attributes of the request. For example, if the request has a “paid” status attribute, then the points added to a priority score may be 60. If the request has an “unpaid” status attribute, then no points may be added to the priority score. If the request has a “new” status attribute, then the points added to the priority score may be 40. If the request has an “existing” status attribute, then no points may be added to the priority score. Other attributes, such as whether the listing is a forced translation, whether the listing has been acquired from a brand having no allocation of translation units, and the like, may have different points as determined by administrators of the listing management system 100.

The request may then be inserted 406 into a priority queue based on the determined priority. In one embodiment, inserting 406 the request into a priority queue based on the determined priority may involve storing the request in a database in association with the determined priority score of the request. In another embodiment, a data structure, such as a linked list, a queue or a directed graph, may be used to represent the priority queue in the listing management system 100. The request for translation may then be processed 408 from the priority queue. One or more translation engines may be used for processing 408 the request for translation. In one embodiment, an API request may be made to a translation engine associated with the business unit for the request in processing 408 the request.

A translated entity may then be received 410. The translated entity may be received 410 as a response to the API request to the translation engine, in one embodiment. In another embodiment, the translated entity may be received 410 through parsing a data file received in response to the processing 408 of the request for translation.

One or more metrics of the translated entity may be determined 412 for the business unit. Metrics of the translated entity may include language(s) that the translated entity was translated into, time and date information of the request, time and date information of the processing of the request, cost of translation in translation units, and other details of the transaction. The translated entity may then be stored 414 for presentation in the listing responsive to the request. The translated entity may be stored 414 in a separate data store, in one embodiment. In another embodiment, the translated entity may be stored in the same data store as all entities in the listing management system 100. In yet another embodiment, each translation of the original text of the entity may be stored as a separate entity in the data store for all entities in the listing management system 100.

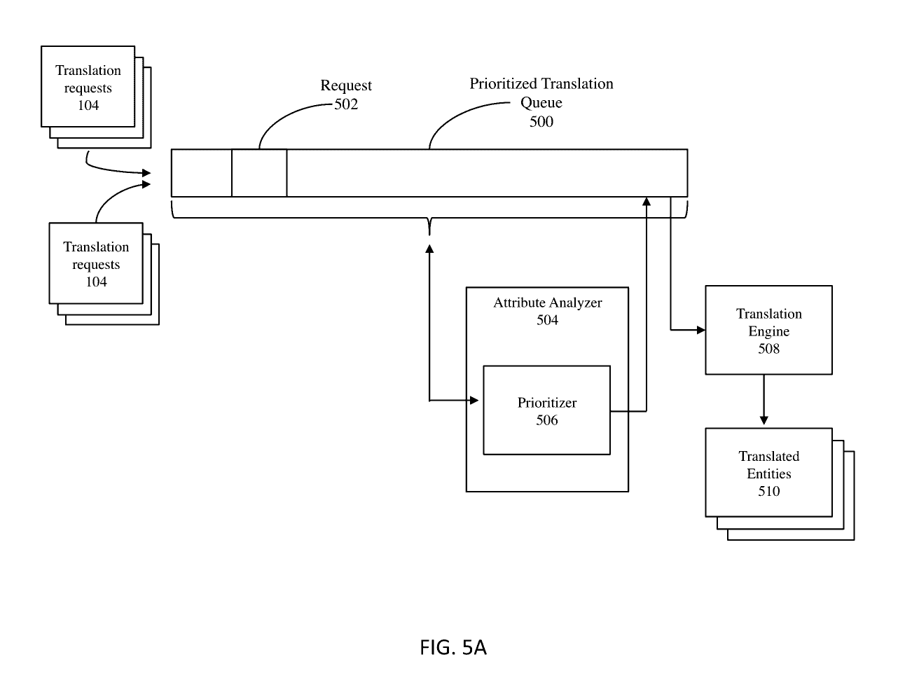

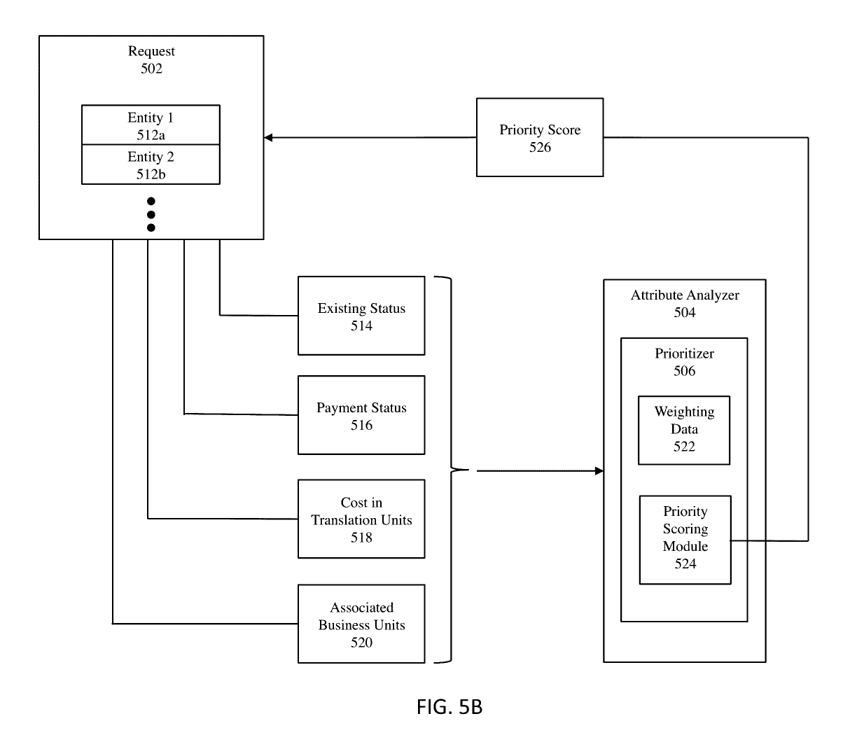

FIG. 5A is a functional block diagram depicting an example of how an attribute analyzer operates on a prioritized translation queue, according to some examples. A prioritized translation queue 500 includes requests 502 that have been placed in a priority order, in one embodiment. Translation requests 104 may be inserted into the prioritized translation queue 500. An attribute analyzer 504 may insert the translation requests 104 in one embodiment. In another embodiment, the attribute analyzer 504 may asynchronously process translation requests 104 to generate a priority. In a further embodiment, the attribute analyzer 504 may process a request 502 inserted in the prioritized translation queue 500 by determining one or more status attributes of the request 502. Status attributes include whether a listing has been paid, whether a translation request is new or existing, and whether a translation request has been processed, for example.

A prioritizer 506 may process the determined status attributes and determine a priority for a request 502 in the prioritized translation queue 500. The priority may include a priority score, in one embodiment. In another embodiment, the priority may be setting of low, medium, or high. As another example, the priority may be determined by the prioritizer 506 in relation to the other requests 502 placed in the prioritized translation queue 500.

For example, a translation request 104 may be received to immediately translate a particular listing based on the fact that the owner of the listing recently paid for a global bundle for a large number of properties. Status attributes of this type of event may include a special “forced translation” attribute, meaning that a request was manually entered by a person accessing the listing management system 100, such as a sales executive or account manager. The prioritizer 506 may be configured to identify the forced translation attribute as an especially highly prioritized attribute, causing the request 502 to be placed at the top of the queue 500.

A translation engine 508 may be requested to process the most prioritized request 502 from the prioritized translation queue 500 by the listing management system 100. In one embodiment, the translation management module 116 may continuously process requests 502 from the queue 500 based on priority order. In another embodiment, the translation management module 116 may have a separate processing thread for each business unit such that multiple threads may process requests 502 from the queue 500 asynchronously. The translation engine 508 may, in a further embodiment, directly access the prioritized translation queue 500 and pull the requests 502 from the queue 500 in priority order. In yet another embodiment, more than one translation engine 508 may be used to process the requests 502 in the prioritized translation queue 500.

Translated entities 510 may be generated from the translation engine 508. In one embodiment translated entities 510 may be formatted as a response from an API request to the translation engine 508. In another embodiment, a translation engine 508 may output one or more requested translations, each in different languages responsive to the request 502, where the one or more requested translations comprise a single translated entity 510. For example, the request 502 may include text describing a property listing in Austin, Tex. The request 502 may specify that the text be translated into five (5) languages. The resulting 5 translations may be stored as a translated entity 510 in the listing management system for the associated data object that represents the listing in the listing management system 100, in one embodiment. The translations may, in another embodiment, result in five translated entities 510 associated with the data object representing the listing in the listing management system 100.

FIG. 5B is a functional block diagram depicting an example of how an attribute analyzer operates on a translation request, according to some examples. A request 502 may include a translation request for several entities of a listing, such as the headline, the description overview of the listing, traveler reviews, prices, availability dates, and so forth. Because each of these entities may change, a new request 502 may be generated with each change to an entity of a listing. As illustrated in FIG. 5B, a request 502 may include several entities 512. In one embodiment, a request 502 may include a request to translate multiple entities 512 of multiple listings in the listing management system 100. The request 502 may include several attributes, such as an existing status 514, a payment status 516, a cost in translation units 518, and an indication of the associated business units 520 in the listing management system 100, in one embodiment.

In another embodiment, each entity 512 included in the request 502 may have separate and distinct attributes, such as existing status 514, payment status 516, cost 518, and associated business units 520. For example, the listing management system 100 may not have a specific budget to address a particular translation of listings needed to operate in Spain. To comply with a law for rental properties, the price of each listing must be translated, for example. As a result, a single request 502 may include all the price entities 512 of all listings in Spain, for example. However, some of the price entities 512 may have already been translated to Spanish. Thus, the existing status attribute 514 would help reduce redundant translation requests.

As described above, an existing status attribute 514 may indicate whether the entity has an existing translation. This status flag may be updated based on receiving translations of the entity. If the entity has not been translated, then the existing status attribute 514 may be set to false. Once it has been translated, then the existing status attribute 514 may be set to true.

A payment status attribute 516 may indicate whether an owner of a listing associated with the entity being requested for translation has paid or subscribed to a level of service that includes translations. Because the listing management system 100 may provide free listings and request payment per booking of the free listings, translation of entities of listings may be reserved for subscribing owners of the listing management system 100, in one embodiment. In another embodiment, a user of the listing management system 100 may upgrade her listing to a paid subscription that includes a global bundle or other cross-selling package that allows the listing to be cross-listed across a network of websites and platforms managed by the listing management system 100. Upon the system 100 receiving confirmation of the paid subscription, a new request 502 may be generated to translate one or more entities 512 based on the paid subscription. For example, certain languages may be more expensive to translate text into, such as Chinese (Mandarin), Japanese, Russian, and so forth. As a result, owners may have to pay for a premium subscription package to translate their listings into the more expensive languages. Thus, a payment status 516 may be associated with a particular language being requested.

Cost in translation units 518 may also be an attribute for a request 502 or each entity 512 within the request 502. A cost 518 may be expressed as an estimated number of translation units needed to translate the particular entity 512 into the one or more languages as indicated in the request 502. For example, a cost 502 in translation units may be determined for a request 502 to translate the word “bathroom” into 5 languages, in one embodiment. In another embodiment, the cost 502 in translation units may be broken out by language for the word “bathroom,” treating the word as a separate entity 512 to be translated.

Associated business units 520 may be identified as attributes of a request 502 or an entity 512. For example, a request 502 may be made by research and development (R&D) of the listing management system 100 in order to test a particular connection to a new translation engine. Thus, the business unit 520 associated with the request 502 in this example would be R&D. Similarly, a request 502 may be made by a marketing team in charge of developing a marketing campaign for a new audience in China. Thus, the request 502 may be associated with the marketing business unit 520.

In one embodiment, a request 502 associated with a business unit 520 may include entities 512 that are associated with multiple business units 520. Continuing the previous example where the marketing business unit requests translation of listings for China, some of the listings may have already been requested for translation, some of the listings may already be translated into Chinese, and some of the entities may have already been requested by other business units. As a result, a reconciliation of which business unit to charge the cost 518 may be needed, and the associated business units 520 may change based on the reconciliation.

The attribute analyzer 504 includes a prioritzer 506 that may include weighting data 522 and a priority scoring module 524 that may generate a priority score 526 for a request 502, in one embodiment. The priority scoring module 524 may include a scoring algorithm that takes as input each attribute of the request 502 to determine the priority score 526 for the request 502, in one embodiment. In another embodiment, the scoring algorithm may select one or more of the attributes of the request 502 for calculating the priority score 526 of the request 502. In a further embodiment, the scoring algorithm may determine a priority score based on attributes of the entities 512 included in a request 502. In yet another embodiment, the scoring algorithm may determine a priority score 526 for the request 502 based on the other requests 502 included in the prioritized translation queue 500.

The priority scoring module 524 may include various heuristics, rules engines, machine learning tools, and probabilistic methods to determine a priority scoring algorithm. For example, certain attributes may be weighted in a hierarchy such that the existence of an attribute may be more heavily weighted, and therefore more prioritized, than another attribute. The weighting data 522 may be initialized by administrators of a listing management system 100, in one embodiment. In another embodiment, the weighting data 522 may change over time based on machine learning and probabilistic methods to optimize translation request prioritization. In a further embodiment, the weighting data 522 may be overridden by a rules engine that pushes a request 502 having a special forced translation attribute to the top of the priority queue 500.

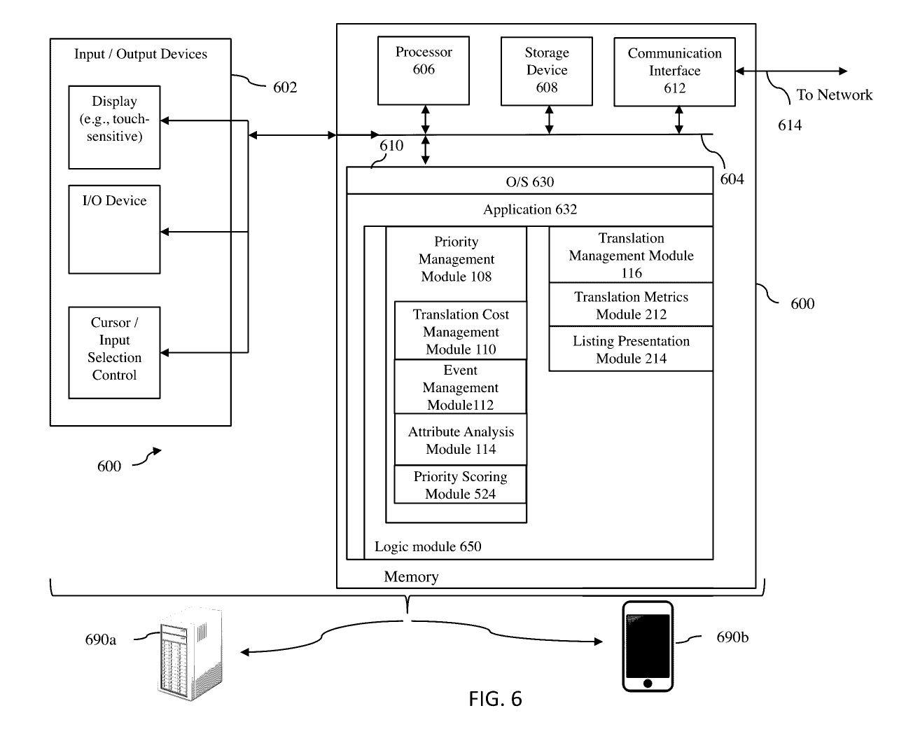

FIG. 6 illustrates an exemplary computing platform disposed in a device configured to prioritize translation requests in a listing management system 100 in accordance with various embodiments. In some examples, computing platform 600 may be used to implement computer programs, applications, methods, processes, algorithms, or other software to perform the above-described techniques.

In some cases, computing platform can be disposed in wearable device or implement, a mobile computing device 690b, or any other device, such as a computing device 690a.

Computing platform 600 includes a bus 604 or other communication mechanism for communicating information, which interconnects subsystems and devices, such as processor 606, system memory 610 (e.g., RAM, etc.), storage device 608 (e.g., ROM, etc.), a communication interface 612 (e.g., an Ethernet or wireless controller, a Bluetooth controller, etc.) to facilitate communications via a port on communication link 614 to communicate, for example, with a computing device, including mobile computing and/or communication devices with processors. Processor 606 can be implemented with one or more central processing units (“CPUs”), such as those manufactured by Intel® Corporation, or one or more virtual processors, as well as any combination of CPUs and virtual processors. Computing platform 600 exchanges data representing inputs and outputs via input-and-output devices 602, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 600 performs specific operations by processor 606 executing one or more sequences of one or more instructions stored in system memory 610, and computing platform 600 can be implemented in a client-server arrangement, peer-to-peer arrangement, or as any mobile computing device, including smart phones and the like. Such instructions or data may be read into system memory 610 from another computer readable medium, such as storage device 608. In some examples, hard-wired circuitry may be used in place of or in combination with software instructions for implementation. Instructions may be embedded in software or firmware. The term “computer readable medium” refers to any tangible medium that participates in providing instructions to processor 606 for execution. Such a medium may take many forms, including but not limited to, non-volatile media and volatile media. Non-volatile media includes, for example, optical or magnetic disks and the like. Volatile media includes dynamic memory, such as system memory 610.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 604 for transmitting a computer data signal.

In some examples, execution of the sequences of instructions may be performed by computing platform 600. According to some examples, computing platform 600 can be coupled by communication link 614 (e.g., a wired network, such as LAN, PSTN, or any wireless network, including WiFi of various standards and protocols, Blue Tooth®, Zig-Bee, etc.) to any other processor to perform the sequence of instructions in coordination with (or asynchronous to) one another. Computing platform 600 may transmit and receive messages, data, and instructions, including program code (e.g., application code) through communication link 614 and communication interface 612. Received program code may be executed by processor 606 as it is received, and/or stored in memory 610 or other non-volatile storage for later execution.

In the example shown, system memory 610 can include various modules that include executable instructions to implement functionalities described herein. System memory 610 may include an operating system (“O/S”) 630, as well as an application 632 and/or logic module 650. In the example shown, system memory 610 includes an priority management module 108 including a translation cost management module 110, an event management module 112, an attribute analysis module 114, and a priority scoring module 524. The system memory 610 may also include a translation management module 116, a translation metrics module 212, and a listing presentation module 214. One or more of the modules included in memory 610 can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a listing management system or one or more of its components, or any process or device described herein, can be in communication (e.g., wired or wirelessly) with a mobile device, such as a mobile phone or computing device, or can be disposed therein.

In some cases, a mobile device, or any networked computing device (not shown) in communication with an action alert controller or one or more of its components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a priority management module 108 or any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, a listing management system, including one or more components, or any process or device described herein, can be implemented in one or more computing devices that include one or more circuits. Thus, at least one of the elements in the above-described figures can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, atone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A method comprising:
receiving, by a processor, data representing a request associated with translating an entity of a listing stored in a database, the request received from a business unit;
determining, by the processor, one or more attributes of the request based at least in part on one or more retrieved attributes of the listing and the business unit from the database;
determining, by the processor, a priority of the request based on the one or more determined attributes;
providing, by the processor, the request to one or more translation engines based on the determined priority;
receiving, by the processor, data representing the entity of the listing translated into one or more languages from the one or more translation engines; and
storing, by the processor, the data representing the entity translated into the one or more languages in association with the listing in the database.

2. The method of claim 1, wherein receiving data representing a request associated with translating an entity of a listing further comprises:
receiving data representing the request from a user device to force translate the entity of the listing.

3. The method of claim 1, wherein receiving data representing a request associated with translating an entity of a listing further comprises:
receiving an indication that the listing is associated with a budget having available translation spend.

4. The method of claim 1, wherein determining one or more attributes of the request based at least in part on the one or more retrieved attributes of the listing and the business unit further comprises:
retrieving a budget associated with the business unit;
determining a cost associated with translating the entity of the listing; and
determining that the budget covers the cost.

5. The method of claim 1, wherein determining a priority of the request based on the one or more determined attributes further comprises:
determining the priority based on the listing having a paid attribute.

6. The method of claim 1, wherein determining a priority of the request based on the one or more determined attributes further comprises:
determining the priority based on the listing having a forced translate attribute.

7. The method of claim 1, wherein determining a priority of the request based on the one or more determined attributes further comprises:
determining the priority based on the listing having a new attribute.

8. The method of claim 1, wherein determining a priority of the request based on the one or more determined attributes further comprises:
determining the priority based on the listing having a paid attribute and a new attribute.

9. A method comprising:
receiving data representing a plurality of requests to translate text within at least a portion of one or more listings associated with a plurality of entities, each request originating from a computer device associated with a business unit having an allocated number of translation units;
analyzing the data representing the requests to identify a translation cost in translation units associated with each request;
determining a priority associated with each request based on the allocated number of translation units associated with the business unit associated with the request and the translation cost in translation units associated with each request;
providing the plurality of requests to one or more translation engines based on the priority of each request;
receiving a plurality of translated text associated with the text within at least the portion of the plurality of entities from the one or more translation engines responsive to the plurality of requests; and
storing the plurality of translated text in association with the one or more listings.

10. The method of claim 9, further comprising:
determining the allocated number of translation units associated with a specific business unit is zero; and
lowering the priority associated with one or more requests associated with the specific business unit.

11. The method of claim 9, further comprising:
detecting a change in an attribute associated with a request; and
modifying the priority of the request in a translation queue based on the change.

12. The method of claim 9, further comprising:
detecting at least one of the translated entities is associated with multiple requests from different business units; and
reconciling the allocated number of translation units associated each of the different business units based on a corresponding translation cost in translation units associated with the at least one of the translated entities.

13. The method of claim 9, wherein determining the priority associated with each request further comprises:
determining, to associate with each request, a truth value associated with an attribute indicating the associated listing is new.

14. The method of claim 9, wherein determining the priority associated with each request further comprises:
determining, to associate with each request, a truth value associated with an attribute indicating the associated listing is paid.

15. The method of claim 9, wherein determining the priority associated with each request further comprises:
determining, to associate with each request, a truth value associated with an attribute indicating the allocated number of translation units associated with the associated business unit is not zero.

16. A system comprising:
a server comprising at least a computer readable medium comprising computer instructions stored thereon and a processor configured, by the computer instructions, to
receive data representing a plurality of requests to translate text within at least a portion of one or more listings associated with a plurality of entities, each request originating from a computer device associated with a business unit having an allocated number of translation units;
analyze the data representing the requests to identify a translation cost in translation units associated with each request;
determine a priority associated with each request based on the allocated number of translation units associated with the business unit associated with the request and the translation cost in translation units associated with each request;
provide the plurality of requests to one or more translation engines over a network based on the priority of each request;
receive a plurality of translated text associated with the text within at least the portion of the plurality of entities from the one or more translation engines over the network responsive to the plurality of requests; and
store the plurality of translated text in association with the one or more listings in the computer readable medium.

17. The system of claim 16, wherein the server is further configured to:
determine the allocated number of translation units associated with a specific business unit is zero; and
lower the priority associated with one or more requests associated with the specific business unit.

18. The system of claim 16, wherein the server is further configured to:
detecting a change in an attribute associated with a request; and
modifying the priority of the request in a translation queue stored on the computer readable medium based on the change.

19. The system of claim 16, wherein the server is further configured:
detect at least one of the translated entities is associated with multiple requests from different business units; and
reconcile the allocated number of translation units associated each of the different business units based on a corresponding translation cost in translation units associated with the at least one of the translated entities.

20. The system of claim 16, wherein the server is further configured to determine a priority of each request based on the listing associated with the request having a paid attribute and a new attribute.
